(19) United States
(12) Patent Application Publication
(10) Pub. No.: US 2008/0007590 A1
(43) Pub. Date: Jan. 10, 2008

(54) Inkjet printer having nozzle capping mechanism and ink priming method using the nozzle capping mechanism

(75) Inventor: Jae-cheol Lee, Hwaseong-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/593,618

(22) Filed: Nov. 7, 2006

(30) Foreign Application Priority Data
Jul. 7, 2006 (JP) 2006-64018

(51) Int. Cl. B41J 2/165

(52) U.S. Cl. 347/29

(57) ABSTRACT

An inkjet printer structure having an improved capping mechanism to smoothly fill inks from ink packs into empty flow channels, and a method of ink priming. The method of ink priming includes mounting a cartridge in which flow channels connected to nozzles are empty on an inkjet printer main body, mounting ink packs to be connected to the flow channels in the cartridge, blocking the nozzles by moving up a cap having sealing protrusions to the cartridge, circulating inks in the ink packs through the flow channels by operating an ink circulation pump for a predetermined time while the nozzles are blocked by the sealing protrusions, and separating the sealing protrusions from the nozzles after the predetermined time elapses.

### CROSS-REFERENCE TO RELATED APPLICATIONS

This application claims priority under 35 U.S.C. §119(a) from Korean Patent Application No.10-2006-0064018, filed on Jul. 7, 2006, in the Korean Intellectual Property Office, the disclosure of which is incorporated herein in its entirety by reference.

### BACKGROUND OF THE INVENTION

1. Field of the Invention

The present general inventive concept relates to an inkjet printer having an improved capping mechanism to protect ejection nozzles of an ink cartridge and a method of ink priming to smoothly fill ink from ink packs to empty flow channels of the ink cartridge using the capping mechanism.

2. Description of the Related Art

In general, a conventional inkjet printer, as illustrated in FIG. 1, has a printing system that prints an image on a paper 1 by ejecting ink received from ink packs 21, 22, 23, and 24 mounted in a cartridge 10 through nozzles 11 installed in a lower part of the cartridge 10. When the ink packs 21, 22, 23, and 24 are mounted in the cartridge 10, inks from the ink packs 21, 22, 23, and 24 are filled in flow channels 12 of the cartridge 10, and are ejected to the outside through the nozzles 11 in the form of ink droplets by an ejecting signal. Conventionally, a negative pressure generator for maintaining a pressure, a filter, and a heater for generating bubbles are installed in each of the flow channels 12. However, for convenience of illustration, these are omitted in FIG. 1.

Reference numeral 13 indicates an ink circulation pump built in the cartridge 10. The ink circulation pump 13 pumps the inks in the ink packs 21, 22, 23, and 24 into the flow channels 12 of the cartridge 10 and circulates the inks between the flow channels 12 of the cartridge 10 and the ink packs 21, 22, 23, and 24. Reference numeral 30 indicates a cap that surrounds the nozzles 11 by being moved up and down by a cam 31.

However, the cartridge 10 is commonly shipped in a state that a transparent ink is initially filled in the flow channels 12. That is, in an outlet 14a and an inlet 14b of the cartridge 10, to which the ink packs 21, 22, 23, and 24 are connected, a transparent ink pack is connected to the outlet 14a of the cartridge 10 to fill the transparent ink in the flow channels 12 while the inlet 14b is blocked. This is because if the flow channels 12 are empty when ink is firstly circulated by connecting the ink packs 21, 22, 23, and 24 to the cartridge 10, that is, if the flow channels 12 are filled with air, the ink will not flow from the ink packs 21, 22, 23, and 24 into the flow channels 12, but only air will circulate even though the ink circulation pump 13 is operated. Therefore, the transparent ink is filled in the flow channels 12 when the cartridge 10 is shipped. When the ink packs 21, 22, 23, and 24 are connected to the cartridge 10, inks in the ink packs 21, 22, 23, and 24 are circulated along the flow channels 12 where the transparent ink is filled by the operation of the ink circulation pump 13. The transparent ink can be mixed with the inks in the ink packs 21, 22, 23, and 24 and used.

However, when the cartridge 10 is shipped with the transparent ink in the flow channels 12 as in the conventional method, the weight of the inkjet printer is increased. Therefore, packing and transportation costs are increased. That is, the weight of the inkjet printer increases in accordance with the weight of a liquid filled in the flow channels 10. Also, packing boxes are required to withstand the weight of the liquid filled when the packing boxes are stacked. Therefore, handling the inkjet printer is difficult.

Furthermore, there is a possibility of leaking the transparent ink. When the inkjet printer is transported, the inkjet printer can undergo an impact, a temperature change, or a pressure change. At this time, when air in the transparent ink filled in the flow channels 12 expands, the transparent ink may leak. When the transparent ink leaks, not only is the packing box damaged, but electrical circuits can also be damaged or corroded. However, if the nozzles 11 are excessively tightly blocked to prevent the leakage of the transparent ink, the nozzles 11 may be damaged.

Although the transparent ink is filled in the flow channels 12 for smooth circulation of ink when the ink packs 21, 22, 23, and 24 are initially connected to the cartridge 10, there are various problems relating to the filling of the transparent ink. Therefore, there is a need to develop an ink priming method without initially filling the transparent ink.

### SUMMARY OF THE INVENTION

The present general inventive concept provides an inkjet printer having an improved capping mechanism that enables smooth ink circulation when a cartridge in which flow channels are empty is connected to the inkjet printer and a method of ink priming using the capping mechanism.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an inkjet printer, including a cartridge having nozzles to eject inks and a flow channel connected to the nozzles, ink packs mounted in the cartridge to supply the inks to the nozzles through the flow channel, an ink circulation pump to circulate the inks in the ink packs through the flow channel, and a cap to reciprocally move to approach and to separate with respect to the cartridge and to cover the nozzles when it approaches the nozzles, wherein the cap comprises sealing protrusions to block the ejection of the inks through the nozzles by tightly contacting the nozzles with the sealing protrusions when the cap approaches the cartridge.

The cap may have two approach positions with respect to the cartridge, and the two approach positions may include a first position where the sealing protrusions tightly contact the nozzles, and a second position where the sealing protrusions surround do not tightly contact the nozzles but the cap still surrounds the nozzles.

The foregoing and/or other aspects and utilities of the present general inventive concept may also be achieved by providing a method of ink priming of an inkjet printer, including mounting a cartridge having flow channels connected to nozzles that are empty on an inkjet printer main body, mounting ink packs to be connected to the flow channels in the cartridge, blocking the nozzles by moving up a cap with respect to the cartridge having sealing protrusions to the nozzles, circulating inks in the ink packs through the flow channels by operating an ink circulation pump for a predetermined time while the nozzles are blocked by the sealing protrusions, and separating the sealing protrusions from the nozzles after the predetermined time elapses.

The predetermined time may be a time taken for the inks in the ink packs to be filled in the flow channels and the nozzles.

The separating of the sealing protrusions from the nozzles may include completely separating the cap from the cartridge and slightly separating the sealing protrusions from the nozzles so that the cap surrounds the nozzles.

The foregoing and/or other aspects and utilities of the present general inventive concept may also be achieved by providing an inkjet printer, including a cartridge having an inkjet head formed with a plurality of nozzles and a flow channel connected to the nozzles, and a cap to cap the inkjet head, and having a plurality of sealing protrusions to tightly contact the corresponding nozzles, wherein the nozzles and the flow channel are empty.

The nozzles and the flow channels may not be filed with one of ink and transparent liquid.

The nozzles may be formed along a plurality of rows on the inkjet head, and the sealing protrusions may be formed along a plurality of rows in the cap to seal the corresponding nozzles when the cap caps the inkjet head.

The ink channel may include a plurality of ink channels corresponding to the respective rows to supply ink to the nozzles.

The inkjet printer may further include a plurality of ink packs to be mounted on the cartridge to supply ink to the ink channel when the cap caps the inkjet head, and the sealing protrusions seals the nozzles.

The inkjet printer may further include a pump to circulate the ink between the ink channel and the ink packs.

The cap may move to a first position where the cap caps the inkjet head and the seal protrusions seal the nozzles, a second position where the cap caps the inkjet head and the seal protrusions spaced-apart from the nozzles by a first distance, and an uncap position where the cap uncaps the inkjet head and the seal protrusions are spaced apart from the nozzles by a second distance.

The cap may be disposed in the first position during an ink filling operation of filling the ink in the ink channel.

The cap may be disposed in the second position when the ink has been filled in the ink channel.

The inkjet printer may further include a suction pump to suck air and ink filled in the nozzles.

The inkjet printer head may include an array type inkjet head.

The inkjet printer may further include a plurality of ink packs on the cartridge to supply ink to the flow channel, wherein the cap caps the inkjet head, and the sealing protrusions tightly contact the nozzles until the flow channel is filled with the ink.

The foregoing and/or other aspects and utilities of the present general inventive concept may also be achieved by providing a method of an inkjet printer, the method including caping an inkjet printer head having a flow channel, a cartridge, and a plurality of nozzles using a cap, and sealing the nozzles with a plurality of sealing protrusions formed on the cap, when the inkjet printer head is capped and the flow channel is empty.

The method may further include mounting ink packs onto the cartridge to supply inks to the flow channels, contacting the sealing protrusions to the nozzles to block the nozzles, operating ink circulation pumps to circulate the inks between the ink packs and the flow channels, and separating the cap from the nozzles.

The separating of the cap may include first separating the cap from the nozzles to unblock the nozzles while the cap still surrounds the nozzles, and second separating the cap from the nozzles to allow a printing medium between the nozzles and the cap.

The method may further include sucking remaining air and/or ink from the flow channels by operating a suction pump connected to the cap after the first separating of the cap.

The method may further include spiting a small amount of ink from the nozzles after the first separating of the cap, and wiping a surface of the nozzles with a wiper after the second separating of the cap.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view illustrating a structure of a conventional inkjet printer;

FIG. 2 is a perspective view illustrating a structure of an inkjet printer according to an embodiment of the present general inventive concept;

FIGS. 3A through 3C are cross-sectional views illustrating a movement of a cap in the inkjet printer of FIG. 2; and

FIG. 4 is a flowchart illustrating a process of ink priming of an inkjet printer according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

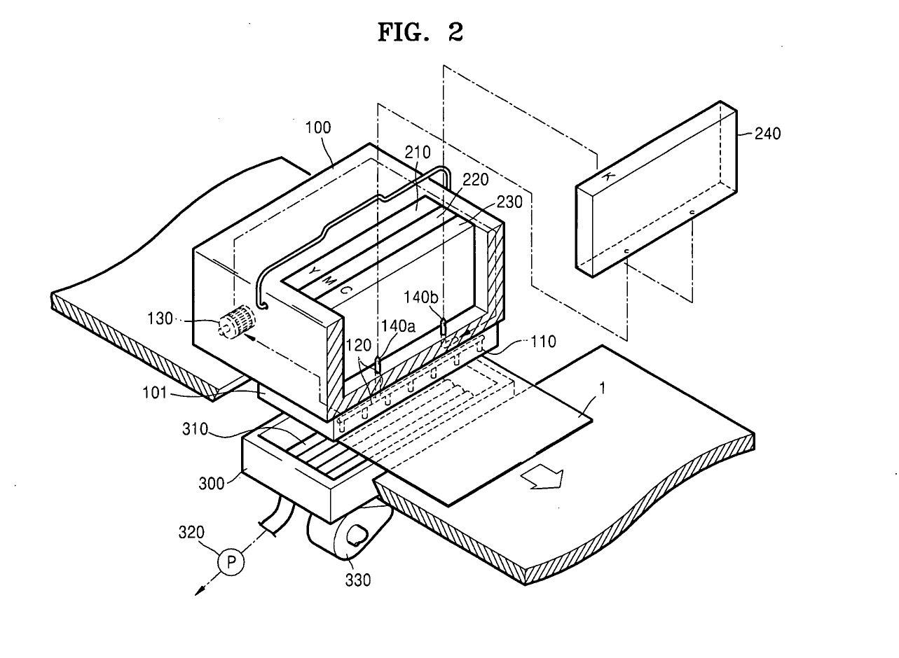

FIG. 2 is a perspective view illustrating a structure of an inkjet printer, mainly a nozzle capping mechanism, according to an embodiment of the present general inventive concept. In the present embodiment, a fixed type ink cartridge is described, that is, an array printing type in which printing is simultaneously performed on an entire width of a paper. However, the present general inventive concept is not limited thereto, and the present embodiment can also be applied to a shuttle printing type ink cartridge in which printing is performed by an ink cartridge that reciprocally moves along a width direction of the paper.

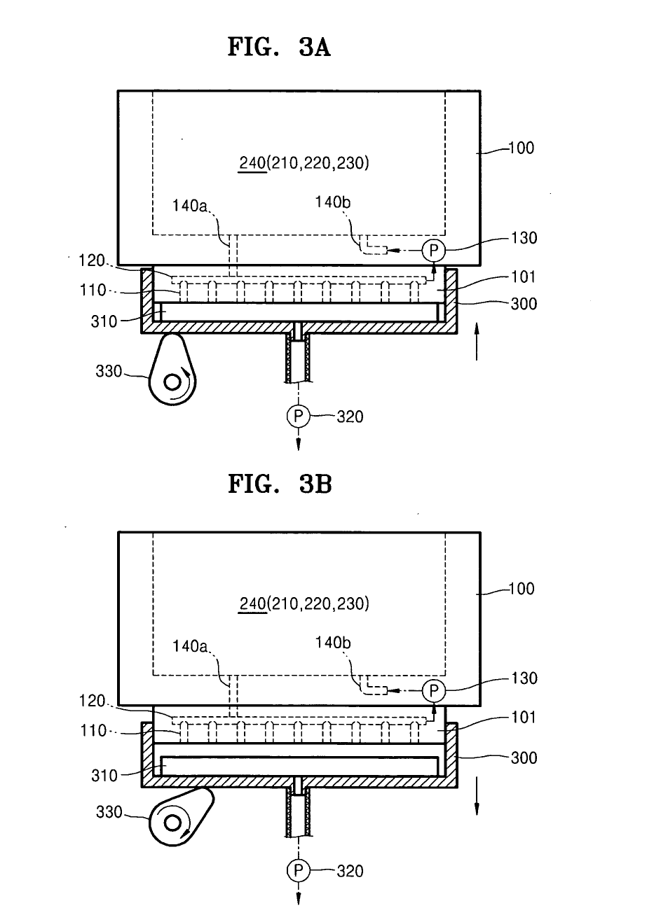

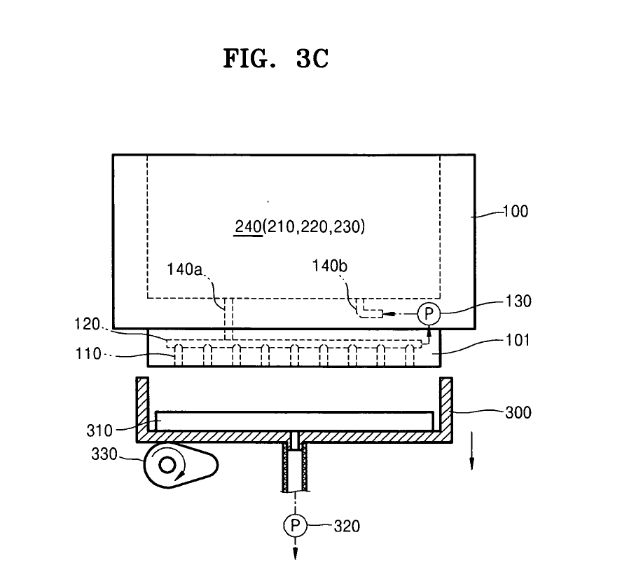

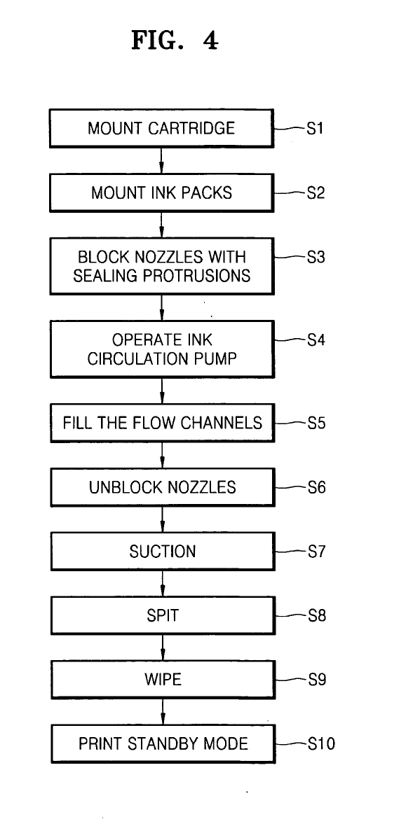

Referring to FIG. 2, the inkjet printer may include a cartridge 100 that includes ink packs 210, 220, 230, and 240 and is mounted above a paper path line and a cap 300 disposed to face nozzles 110 formed on an inkjet head 101 of the cartridge 100 below the paper path line. The cartridge 100 may also include flow channels 120 having connectors 140a and 140b to be connected to the ink packs 210, 220, 230, and 240, and an ink circulation pump 130 disposed to control circulation between an inlet, for example, connecter 140b, and the flow channels 120. Accordingly, the inkjet printer of the present embodiment has a structure that, during printing, inks stored in the ink packs 210, 220, 230, and 240 of the cartridge 100 are ejected to a paper 1 through the nozzles 110, and during a stand by mode or a suction mode (refer to FIG. 3B), the cap 300 moves up and surrounds the nozzles 110 to protect the nozzles 110. The inkjet printer may include a negative pressure generator to maintain a pressure, a filter, and a heater to generate bubbles installed in each of the flow channels 120. However, for convenience of illustration, these are omitted in the drawings of structures of the present invention.

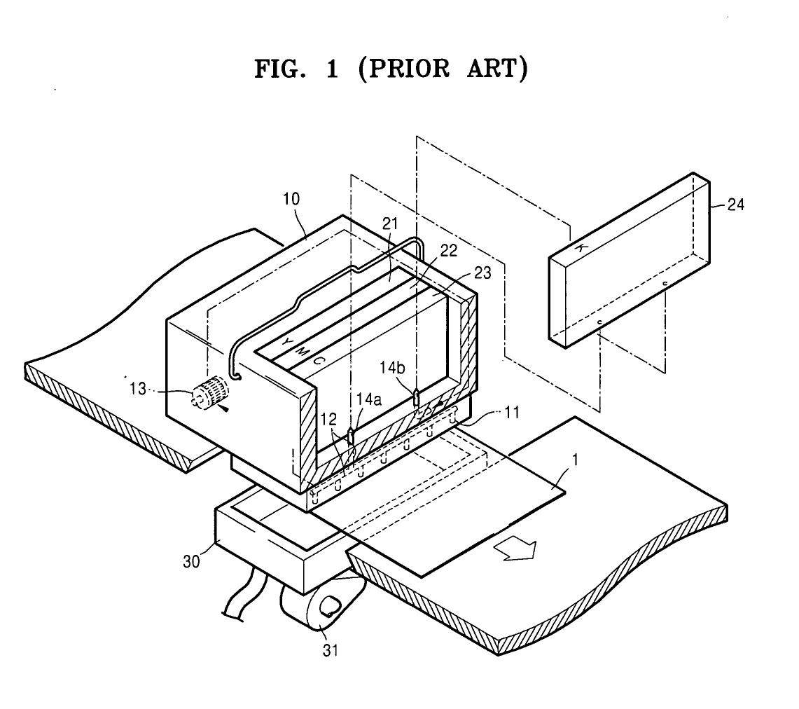

Sealing protrusions 310 are formed in the cap 300 to block the ejection of ink through the nozzles 110 by tightly contacting the nozzles 110 with the sealing protrusions 310 when necessary. In a conventional inkjet printer of FIG. 1, a cap 30 is simply formed to surround nozzles 11. However, according to the present general inventive concept, a capping mechanism that can completely block the nozzles 110 using the sealing protrusions 310 formed in the cap 300 is provided. The cap 300 moves up and down by the rotation of a cam 330. The cam 330 rotates by a driving force provided by a motor (not illustrated). FIGS. 3A through 3C are cross-sectional views illustrating the movement of the cap 300 in the inkjet printer of FIG. 2, according to an embodiment of the present general inventive concept. A highest point of the cam 330 or the cap 300 is, as illustrated in FIG. 3A, a position (a first position) where the sealing protrusions 310 are tightly contacted to the nozzles 110, a lowest point of the cap 300 is, as illustrated in FIG. 3C, a position (an uncap position) where the cap 300 is completely lowered below the paper path line, and a middle point of the cap 300 is, as illustrated in FIG. 3B, a position (a second position) where the cap 300 surrounds the inkjet head 101 to protect the nozzles 110 but the sealing protrusions 310 are spaced apart from the nozzles 110. When the nozzles 110 are formed along a plurality of rows on the inkjet head 101, the sealing protrusions 310 may be formed along a plurality of rows in the cap 300. The sealing protrusions may be spaced apart same as the nozzles. The sealing protrusions may be made of an elastic material.

The reason why the nozzles 110 are formed to be blocked with the sealing protrusions 310 by adjusting the position of the cap 300 in more than two steps is to realize a system in which ink can be circulated when the flow channels 120 in the cartridge 100 are empty. That is, in the conventional inkjet printer of FIG. 1, when the cartridge 10 including the ink packs 21, 22, 23, and 24 is initially installed, the inks stored in the ink packs 21, 22, 23, and 23 are circulated by mixing with the transparent ink already filled in the flow channels 12 when the ink circulation pump 13 is operated. However, when the capping mechanism according an embodiment of the present general inventive concept is used as illustrated in FIGS. 2-3C, the inks in the ink packs 210, 220, 230, and 240 can be smoothly circulated by an ink circulation pump 130 even though a liquid, such as the transparent ink or fluid, is not filled in the flow channels 120. Accordingly, the cartridge 100 can be shipped with empty flow channels 120, and thus, it is advantageous for handling a product such as an inkjet printer.

A method of circulating the inks in ink packs 210, 220, 230, and 240 through empty flow channels 120 of the cartridge 100 will now be described with reference to FIGS. 2 through 4.

The cartridge 100 is mounted on an inkjet printer main body (not illustrated) in which the flow channels 120 of the cartridge 100 are empty (operation S1). Accordingly, the cartridge 100 is lightweight and there is no possibility of leakage of a liquid in the flow channels 120 when an impact or a vibration is applied to the cartridge 100. Afterwards, the ink packs 210, 220, 230, and 240 are installed in the cartridge 100 (operation S2), and the ink circulation pump 130 is started (operation S4). Prior to starting the ink circulation pump 130, as illustrated in FIG. 3A, the cap 300 is moved up to the highest position (first position) by operating the cam 330 so that nozzles 110 can tightly contact the sealing protrusions 310 (operation S3). When the nozzles 110 are blocked by the sealing protrusions 310, the ink circulation pump 130 is started (operation S4). Then, an air pressure generated from the ink circulation pump 130 is solely transmitted to the inks in the ink packs 210, 220, 230, and 240 without leaking to an outside thereof, and thus, the inks in the ink packs 210, 220, 230, and 240 can be drawn into the flow channels 120. That is, if the nozzles 110 are not blocked by the sealing protrusions 310, air can flow in and out of the nozzles 110, and thus, the air pressure generated from the ink circulation pump 130 cannot be transmitted to the inks in the ink packs 210, 220, 230, and 240. However, when the ink circulation pump 130 is operated while the nozzles 110 are blocked, an air pressure to suck and push a fluid can be solely transmitted to the inks in the ink packs 210, 220, 230, and 240, and thus the inks in the ink packs 210, 220, 230, and 240 can be drawn into the flow channels 120. When the ink circulation pump 130 is operated for an appropriate time, the inks in the ink packs 210, 220, 230, and 240 will be drawn and completely fill the flow channels 120. The time to operate the ink circulation pump 130 to fill the flow channels 120 can be set in a printer controller (not illustrated) using a value obtained from an experiment. For example, after the cartridge 100 and the ink packs 210, 220, 230, and 240 are initially mounted in the inkjet printer main body, an ink priming button is pressed. Then, the printer controller moves up the cap 300 so that the sealing protrusions 310 block the nozzles 110, and operates the ink circulation pump 130 for a predetermined time to fill the flow channels 120.

By the above operation, the flow channels 120 are filled with inks (operation S5). Afterwards, as illustrated in FIG. 3B, the cap 300 is lowered to a middle position (second position) to unblock the nozzles 110 while still surrounding the nozzles 110 (operation S6), and, in this state, a suction pump 320 connected to the cap 300 is operated to suck up air remaining in the flow channels 120 (operation S7). It is possible that a small amount of the inks may be sucked from the nozzles 110 by the suction pump 320 when the suction pump 320 is operated to suck up air remaining in the flow channels 120 during operation S7.

Then the cartridge 100 is ready to print. However, to perform a clean printing operation, a spitting process (operation S8), that is, a small amount of ink is ejected through all or a portion of the nozzles 110 to prevent ink from being solidified, and a wiping process (operation S9), that is, surfaces of the nozzles 110 are cleaned using a wiper (not illustrated) installed on the inkjet printer main body, are performed. Next, the inkjet printer enters a print stand by mode (operation S10). The spitting and wiping processes may be performed after the cap 300 is completely lowered below the path line of a paper 1. Descriptions of the spitting and wiping processes are omitted since these processes are well-known processes.

When ink priming is performed as described above, inks can be smoothly drawn from the ink packs 210, 220, 230, and 240, and the flow channels 120 can be filled with the inks, even though the flow channels 120 of the cartridge 100 are empty. That is, even though the flow channels 120 are not filled with a liquid, such as a transparent ink or fluid, when the cartridge 100 is shipped, the priming process described above can smoothly draw inks from the ink packs 210, 220, 230, and 240, after they are installed, to perform a printing operation. Accordingly, handling difficulties due to a weight and a risk of the transparent ink leaking from the flow channels 120 are overcome.

When printing, sometimes, the printing may not be properly performed due to air present in the flow channels 120. In this case, according to the present general inventive concept, inks can be smoothly circulated if the ink circulation pump 130 is operated for an appropriate time while the nozzles 110 are blocked with the sealing protrusions 310.

Also, the cartridge 100 may be separated from the inkjet printer main body for a short period of time for a simple maintenance procedure. In this case, the cap 300 can move to the highest position and the sealing may tightly contact the nozzles 110. At this time, since the flow channels 120 are filled with inks, the inkjet printer can be readily used after performing the spitting and wiping processes in which solidified ink is removed and contaminated nozzle surfaces are cleaned.

Once the ink priming is completed according to the method described above, printing can be performed in the same way as in a conventional inkjet printer.

As described above, an inkjet printer that can be used when a cartridge is initially shipped without filling ink in flow channels with a transparent liquid, such as a transparent ink or fluid, is realized.

An inkjet printer and an ink priming method according to the present general inventive concept have the following advantages.

First, cartridges can be shipped without filling a liquid into flow channels. Thus, transportation and packing are easy since the product is lightweight.

Second, a risk of electrical circuits being damaged or corroded due to leaking of a transparent ink can be avoided since the flow channels of the cartridge are empty.

Third, not only during ink priming but also when air is filled in the flow channels, smooth ink circulation can be realized by operating an ink circulation pump while blocking nozzles, thereby enabling ink circulation when air and/or ink are in the flow channels.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet printer, comprising:
a cartridge having nozzles to eject inks and a flow channel connected to the nozzles;
ink packs mounted in the cartridge to supply the inks to the nozzles through the flow channel;
an ink circulation pump to circulate the inks in the ink packs through the flow channels; and
a cap to reciprocally move to approach and to separate with respect to the cartridge and to cover the nozzles when it approaches the nozzles,
wherein the cap comprises sealing protrusions to block the ejection of the inks through the nozzles by tightly contacting the nozzles with the sealing protrusions when the cap approaches the cartridge.

2. The inkjet printer of claim 1, wherein the cap has two approach positions with respect to the cartridge, and the two approach positions comprise a first position where the sealing protrusions tightly contact the nozzles, and a second position where the sealing protrusions do not tightly contact the nozzles but the cap still surrounds the nozzles.

3. A method of ink priming of an inkjet printer, comprising:
mounting a cartridge having flow channels connected to nozzles that are empty on an inkjet printer main body;
mounting ink packs to be connected to the flow channels in the cartridge;
blocking the nozzles by moving up a cap with respect to the cartridge having sealing protrusions to the nozzles;
circulating inks in the ink packs through the flow channels by operating an ink circulation pump for a predetermined time while the nozzles are blocked by the sealing protrusions; and
separating the sealing protrusions from the nozzles after the predetermined time elapses.

4. The method of claim 3, wherein the predetermined time is a time taken for the inks in the ink packs to be filled in the flow channels and the nozzles.

5. The method of claim 3, wherein the separating of the sealing protrusions from the nozzles comprises completely separating the cap from the cartridge and slightly separating the sealing protrusions from the nozzles so that the cap surrounds the nozzles.

6. An inkjet printer, comprising:
a cartridge having an inkjet head formed with a plurality of nozzles and a flow channel connected to the nozzles; and
a cap to cap the inkjet head, and having a plurality of sealing protrusions to tightly contact the corresponding nozzles,
wherein the nozzles and the flow channel are empty.

7. The inkjet printer of claim 6, wherein the nozzles and the flow channel are not filed with one of ink and transparent liquid.

8. The inkjet printer of claim 6, wherein the nozzles are formed along a plurality of rows on the inkjet head, and the sealing protrusions are formed along a plurality of rows in the cap to seal the corresponding nozzles when the cap caps the inkjet head.

9. The inkjet printer of claim 8, wherein the ink channel comprises a plurality of ink channels corresponding to the respective rows to supply ink to the nozzles.

10. The inkjet printer of claim 6, further comprising:
a plurality of ink packs to be mounted on the cartridge to supply ink to the ink channel when the cap caps the inkjet head and the sealing protrusions seals the nozzles.

11. The inkjet printer of claim 6, further comprising:
a pump to circulate the ink between the ink channel and the ink packs.

12. The inkjet printer of claim 6, wherein the cap moves to a first position where the cap caps the inkjet head and the seal protrusions seal the nozzles, a second position where the cap caps the inkjet head and the seal protrusions are spaced-apart from the nozzles by a first distance, and an uncap position where the cap uncaps the inkjet head and the seal protrusions are spaced apart from the nozzles by a second distance.

13. The inkjet printer of claim 12, wherein the cap is disposed in the first position during an ink filling operation of filling the ink in the ink channel.

14. The inkjet printer of claim 12, wherein the cap is disposed in the second position when the ink has been filled in the ink channel.

15. The inkjet printer of claim 14, further comprising:
a suction pump to suck air and ink filled in the nozzles.

16. The inkjet printer of claim 6, wherein the inkjet printer head comprises an array type inkjet head.

17. The inkjet printer of claim 6, further comprising:
a plurality of ink packs on the cartridge to supply ink to the flow channel, wherein the cap caps the inkjet head, and the sealing protrusions tightly contact the nozzles until the flow channel is filled with the ink.

18. A method of an inkjet printer, the method comprising:
caping an inkjet printer head having a flow channel, a cartridge, and a plurality of nozzles using a cap; and
sealing the nozzles with a plurality of sealing protrusions formed on the cap, when the inkjet printer head is capped and the flow channel is empty.

19. The method of claim 18, further comprising:
mounting ink packs onto the cartridge to supply inks to the flow channels;
contacting the sealing protrusions to the nozzles to block the nozzles;
operating ink circulation pumps to circulate the inks between the ink packs and the flow channels; and
separating the cap from the nozzles.

20. The method of claim 19, wherein the separating of the cap comprises:
first separating the cap from the nozzles to unblock the nozzles while the cap still surrounds the nozzles; and
second separating the cap from the nozzles to allow a printing medium between the nozzles and the cap.

21. The method of claim 20, further comprising:
sucking remaining air and/or ink from the flow channels by operating a suction pump connected to the cap after the first separating of the cap.

22. The method of claim 20, further comprising:
spiting a small amount of ink from the nozzles after the first separating of the cap; and
wiping a surface of the nozzles with a wiper after the second separating of the cap.
